(19) United States
(12) Patent Application Publication
(10) Pub. No.: US 2013/0083534 A1
(43) Pub. Date: Apr. 4, 2013

(54) LIGHT-EMITTING DIODE LAMP

(71) Applicants: YUN CHEN, Shenzhen City (CN); JIAN-GANG WANG, Shenzhen City (CN); RUI-XIAN LI, Shenzhen City (CN)

(72) Inventors: YUN CHEN, Shenzhen City (CN); JIAN-GANG WANG, Shenzhen City (CN); RUI-XIAN LI, Shenzhen City (CN)

(73) Assignee: FOXSEMICON INTEGRATED TECHNOLOGY, INC., Chu-Nan (TW)

(21) Appl. No.: 13/336,015

(22) Filed: Dec. 23, 2011

(30) Foreign Application Priority Data
Sep. 29, 2011 (TW) 100135148

(51) Int. Cl. F21V 21/14

(52) U.S. Cl. 362/249.03

(57) ABSTRACT

A light-emitting diode lamp includes a lamp shield and light-emitting diode modules mounted in the lamp shield. The lamp shield includes two side bars spaced from each other. The light-emitting diode modules are located between the two side bars and arranged side by side along lengthwise direction of the side bars. Each of the light-emitting diode modules is rotatably mounted on the two side bars.

### BACKGROUND

1. Technical Field

The present disclosure generally relates to illuminating apparatus, and particularly to a light-emitting diode lamp.

2. Description of Related Art

Nowadays, light-emitting diode lamps become more and more popular in people's everyday life because of their high light-emitting efficiency and long life span. Different light-emitting diode lamps are developed for different occasions, such as street lamps on the streets for illuminating the roads/streets, reading lamps in houses for providing required lighting when one reads. Generally, each of these light-emitting diode lamps has a fixed light output angle. The light output angle of the light-emitting diode lamp can't be changed as a change of an occasion in which the light-emitting diode lamps are applied. Therefore, the light-emitting diode lamps usually have special applications in special occasions and can not be used in other occasions. It needs to contrive different light-emitting diode lamps to meet different occasions, waste is thus resulted.

What is needed, therefore, is a light-emitting diode lamp which can overcome the limitations described.

### BRIEF DESCRIPTION OF THE DRAWINGS

FIG. 1 is an isometric, assembled view of a light-emitting diode lamp in accordance with a first embodiment of the present disclosure.

FIG. 2 is an exploded view of the light-emitting diode lamp of FIG. 1.

FIG. 3 is another exploded view of the light-emitting diode lamp of FIG. 1, viewed from a different aspect.

FIG. 4 is an enlarged isometric view of the circled portion IV of FIG. 2.

FIG. 5 is an enlarged isometric view of the circled portion V of FIG. 2.

FIG. 6 is an isometric, assembled view of a light-emitting diode lamp in accordance with a second embodiment of the present disclosure.

FIG. 7 is an isometric, assembled view of a light-emitting diode lamp in accordance with a third embodiment of the present disclosure.

FIG. 8 is an isometric, assembled view of a light-emitting diode lamp in accordance with a fourth embodiment of the present disclosure.

FIG. 9 is an isometric, assembled view of a light-emitting diode lamp in accordance with a fifth embodiment of the present disclosure.

### DETAILED DESCRIPTION

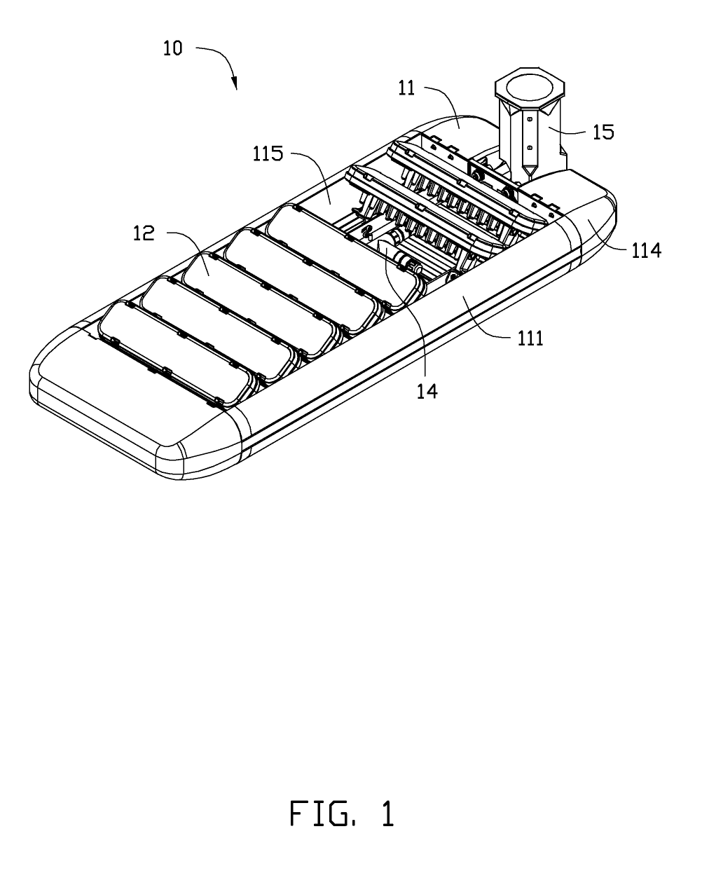

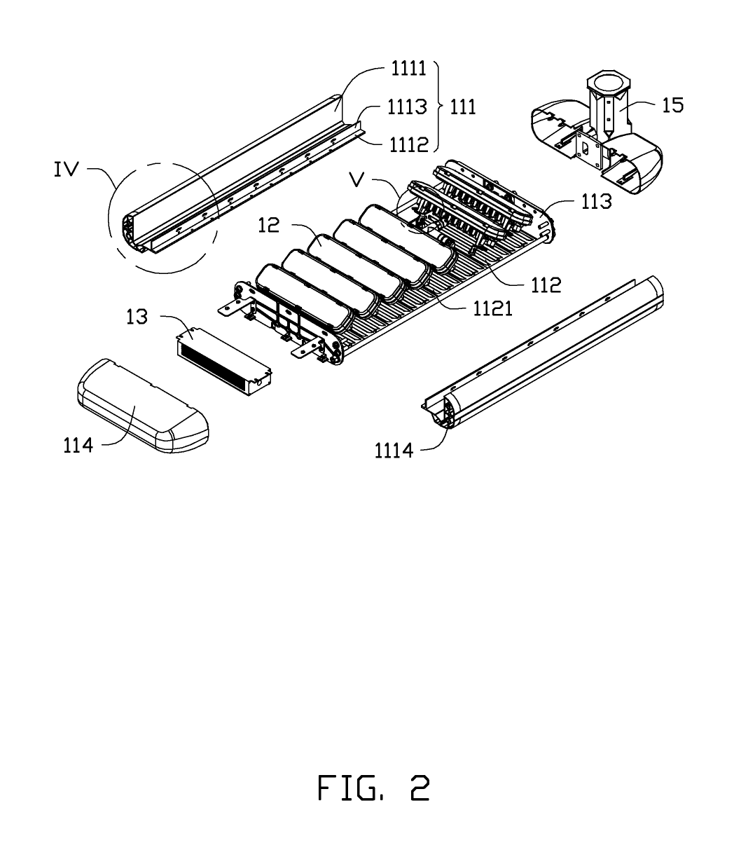

Referring to FIGS. 1-3, a light-emitting diode (LED) lamp 10 in accordance with a first embodiment of the present disclosure is shown. The LED lamp 10 includes a first lamp shield 11, a plurality of light-emitting diode (LED) modules 12, a drive module 13, a wire assembly 14 and a supporting rack 15.

The lamp shield 11 is substantially rectangular and includes two side bars 111, a plurality of substrates 112, two baffle plates 113 and two tip covers 114. The two side bars 111 are formed by aluminum extrusion. The two side bars 111 are parallel to each other. Each of the two side bars 111 includes a strip-shaped, elongated main plate 1111, a first flange 1112 extending horizontally perpendicularly from a lateral side of the main plate 1111, a second flange 1113 perpendicularly extending upwardly adjacent to an outer side of the first flange 1112. The second flange 1113 and the main plate 1111 are parallel to and face each other. A plurality of heat dissipation structures 1114 are formed at an outer surface of the main plate 1111 away from the first and second flanges 1112, 1113.

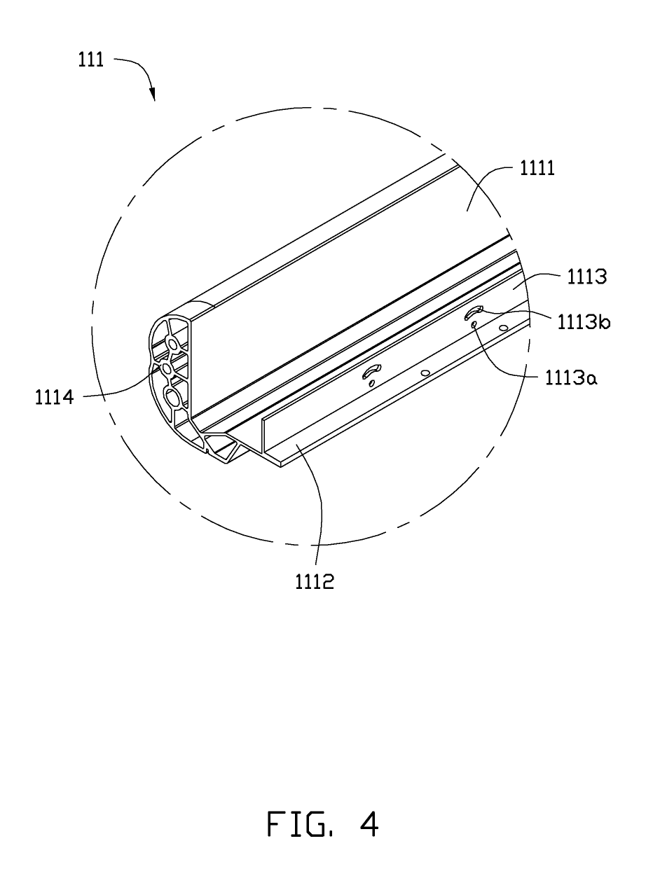

Referring to FIG. 4, the second flange 1113 defines a plurality of axial holes 1113a and a plurality of sliding slot 1113b corresponding to the axial holes 1113a. Each of the axial holes 1113a is adjacent to a corresponding sliding slot 1113b. The axial hole 1113a is circular and adjacent to the first flange 1112. The sliding slot 1113b is arc-shaped and away from the first flange 1112. The axial hole 1113a is located between the first flange 1112 and the corresponding sliding slot 1113b. The axial hole 1113a and the corresponding sliding slot 1113b are homocentric.

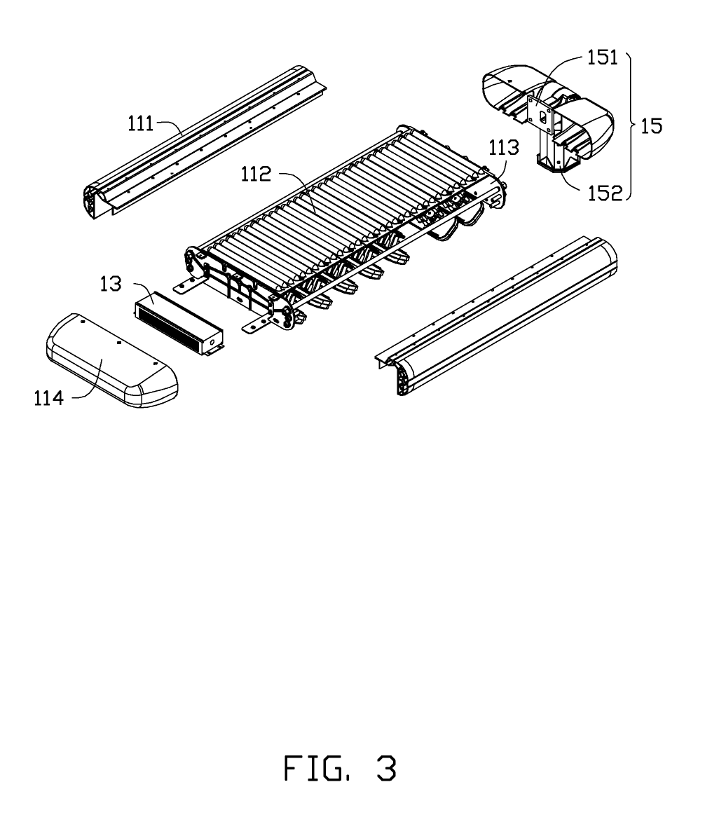

Referring to FIG. 3, the substrates 112 are positioned between the two side bars 111 and arranged side by side along a lengthwise direction of the side bars 111. Two opposite ends of each of the substrates 112 are respectively mounted to the two side bars 111. Each of the substrates 112 defines a plurality of ventilation holes 1121 therein for dissipating heat of the LED module 12. The ventilation holes 1121 are strip-shaped and are arranged in an array. The two baffle plates 113 are respectively located at outmost ends of the substrates 112. A receiving space 115 is cooperatively defined by the side bars 111, the baffle plate 113 and the substrates 112, for receiving the LED modules 12. In this embodiment, the two tip covers 114 are semi-elliptic and hollow. Each of the two tip covers 114 is mounted on an outer surface of one of the baffle plates 113 away from the side bars 111.

The LED modules 12 are located between the two side bars 111 and arranged side by side along the lengthwise direction of the side bars 111. Each of the LED modules 12 is substantially rectangular, corresponding to a substrate 112.

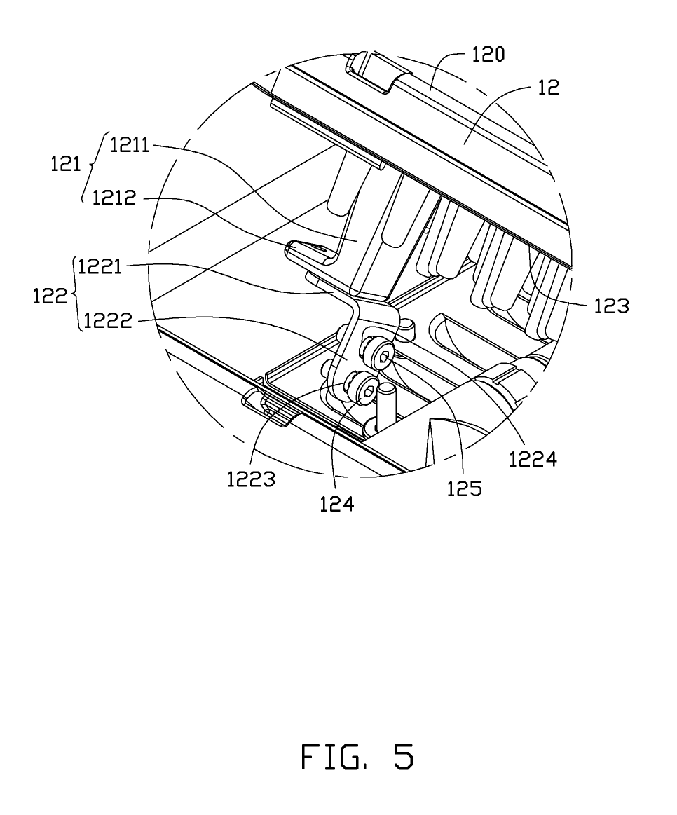

Referring to FIG. 5, the LED module 12 emits light from a front surface 120 thereof. Two mounting arms 121 are formed on a back surface 123 of the LED module 12. The two mounting arms 121 are located respectively adjacent to two opposite ends of the LED module 12. Each of the mounting arms 121 is L-shaped and includes a connecting portion 1211 extending from the back surface 123 of the LED module 12 and a mounting portion 1212 extending perpendicularly out from a free end of the connecting portion 1211 towards one of the side bars 111. Each of the mounting arms 121 connects with a rotation member 122. The LED module 12 is rotatably mounted to the side bars 111 of the lamp shield 11 by the rotation members 122.

Each of the rotation members 122 is L-shaped, and includes a first connecting arm 1221 and a second connecting arm 1222 perpendicular to the first connecting arm 1221. The first connecting arm 1221 is mounted to the mounting portion 1212 of a corresponding mounting arm 121. The second connecting arm 1222 defines a positioning hole 1223 and a guiding hole 1224 therein corresponding to the axial holes 1113a and the sliding slot 1113b of a corresponding side bar 111. The positioning hole 1223 is adjacent to a free end of the second connecting arm 1222 and aligned with the axial hole 1113a of the corresponding side bar 111 for receiving a positioning member 124 therein. The guiding hole 1224 is adjacent to the first connecting arm 1221 and aligned with the sliding slot 1113b for receiving a guiding member 125 therein. When the rotation member 122 rotates with respect to the positioning member 124, the guiding member 125 slides along the sliding slot 1113b of the side bar 111, and each of the LED modules 12 rotates accompanying with the rotation member 124 with respect to the lamp shield 11. Therefore, a light output angle of the LED lamp 10 is adjustable.

The drive module 13 is used to drive the LED modules 12. The drive module 13 is mounted at the outer surface of one of the baffle plate 113 and received in the tip cover 114 mounted at the outer surface of the baffle plate 113. The wire assembly 14 connects the drive module 13 with the LED modules 12 and an outer power supply.

The supporting rack 15 extends into another tip cover 114 opposite to the drive module 13. The supporting rack 15 is a rotation adjustor. The supporting rack 15 includes a pivot 151 received in the tip cover 114 and a sleeve 152 perpendicularly and rotatably intersecting the pivot 151. The sleeve 152 is used to mount the LED lamp 10 to a lamp pole. Therefore, the lamp shield 11 of the LED lamp 10 can rotate with respect to the lamp pole to further adjust the light output angle of the LED lamp 10.

In the aforementioned embodiment, the light output angle of the LED lamp 10 can be conveniently adjusted through rotations of the rotation member 122 and the supporting rack 15. This enables the LED lamp 10 to change the light output angle as a change of an occasion in which the LED lamp 10 is applied, and thus the LED lamp 10 can meet different light output angle requirements of different occasions.

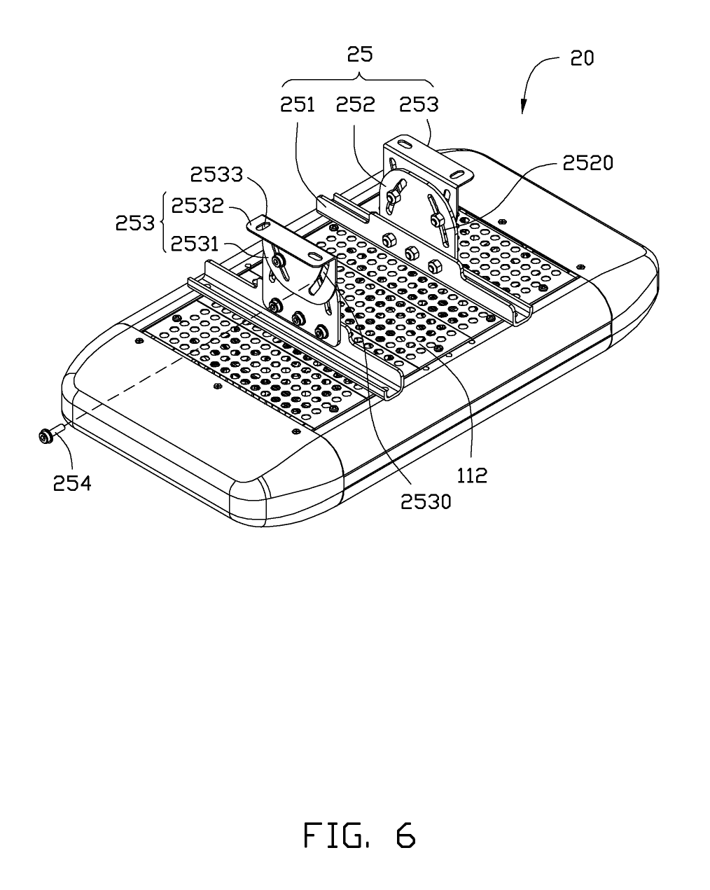

FIG. 6 presents an LED lamp 20 in accordance with a second embodiment of the present disclosure. The LED lamp 20 is similar to that of the first embodiment but differs from that of the first embodiment in supporting racks 25. The LED lamp 20 includes two supporting racks 25, and each of the two supporting racks 25 includes a mounting flake 251, a first rotation plate 252 and a second rotation plate 253. The mounting flakes 251 of the two supporting racks 25 are mounted on a substrate 112 of the LED lamp 20 and parallel to each other. The first rotation plate 252 of each supporting rack 25 is mounted at a middle portion of the mounting flake 251 of the supporting rack 52. The first rotation plate 252 is flat and defines two first guiding slots 2520 therein. Each of the two first guiding slots 2520 is arc-shaped. The two first guiding slots 2520 are axisymmetric with each other. A distance between the two first guiding slots 2520 decreases gradually towards the second rotation plate 253.

The second rotation plate 253 includes a flat main body 2531 and a mounting flange 2532 extending perpendicularly from a top side of the main body 2531. The main body 2531 defines two second guiding slots 2530 therein. Each of the two second guiding slots 2530 is arc-shaped. The two second guiding slots 2530 are axisymmetric with each other. A distance between the two second guiding slots 2530 decreases gradually towards the first rotation plate 252. The mounting flange 2532 is strip-shaped and defines two mounting holes 2533 therein adjacent to two opposite ends thereof for mounting the LED lamp 20 on a ceiling or others. Each of the mounting holes 2533 is strip-shaped. One of the mounting holes 2533 is parallel to the main body 2531, and the other one of the mounting holes 2533 is perpendicular to the main body 2531. The first rotation plate 252 and the second rotation plate 253 of each of the supporting racks 25 are overlap with each other. Each of the first guiding slots 2520 of the first rotation plate 252 intersects a corresponding one of the second guiding slots 2530 of the second rotation plate 253. A fastener 254 extends through an intersection of the first guiding slot 2520 and the corresponding second guiding slots 2530, mounting the first rotation plate 252 and the second rotation plate 253 together. The fastener 254 is slidable in the first guiding slot 2520 and the second guiding slot 2530. Therefore, the first rotation plate 252 and the second rotation plate 253 are moveable and rotatable with respect to each other. These configurations can further adjust a light output angle of the LED lamp 20. During application, the LED lamp 20 can be mounted at different occasions through the mounting flanges 253 of supporting rack 25 without redesign of the LED lamp 20. Cost is thus avoided. The LED lamp 20 is fit for tunnel illuminating.

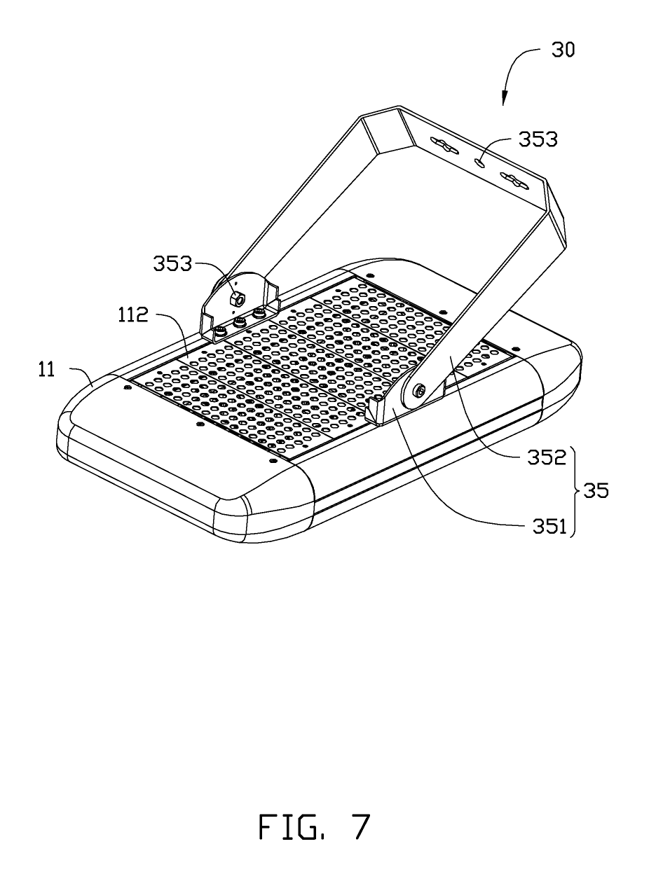

FIG. 7 presents an LED lamp 30 in accordance with a third embodiment of the present disclosure. The LED lamp 30 is similar to that of the first embodiment but differs from that of the first embodiment in a supporting rack 35. The supporting rack 35 of the LED lamp 30 is U-shaped and includes two mounting flakes 351 and a U-shaped portion 352. The two mounting flakes 351 are respectively mounted at two opposite ends of a substrate 112. A middle segment of the U-shaped portion 352 defines a plurality of mounting holes 353 therein for mounting the LED lamp 30 on a ceiling or others. Two opposite ends of the U-shaped portion 352 are respectively mounted on the two mounting flakes 351 through two fasteners 353. In this embodiment, the fasteners are two screws. The mounting flakes 351 are rotatable with respect to the U-shaped portion 352 to further adjust a light output angle of the LED lamp 30.

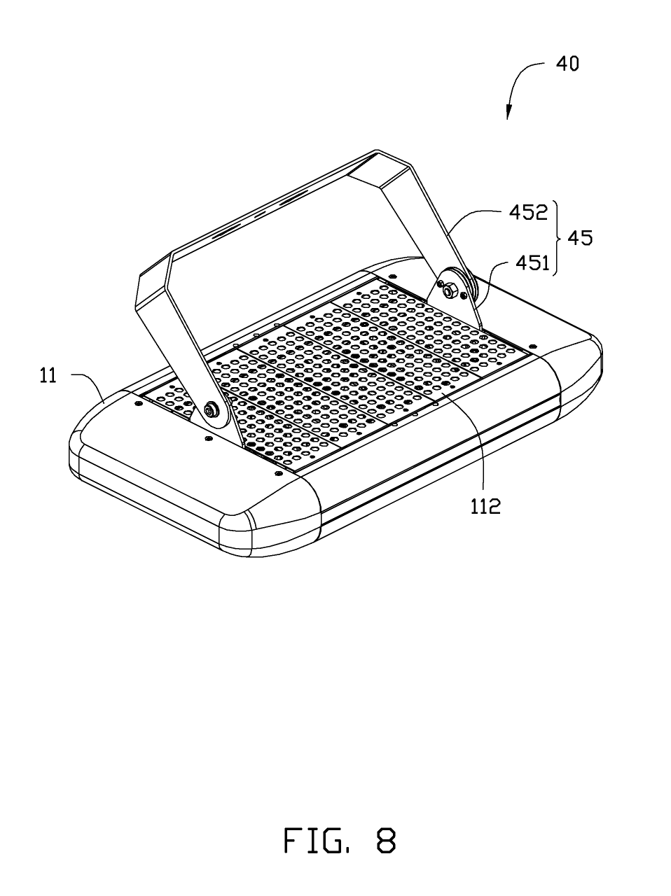

FIG. 8 presents an LED lamp 40 in accordance with a fourth embodiment of the present disclosure. The LED lamp 40 is similar to that of the third embodiment but differs from that of the third embodiment in a mounting manner of a supporting rack 45. The supporting rack 45 includes two mounting flakes 451 respectively mounted on two outmost substrates 112 of the lamp shield 11, and a U-shaped portion 452 rotatably connected to the two mounting flakes 451.

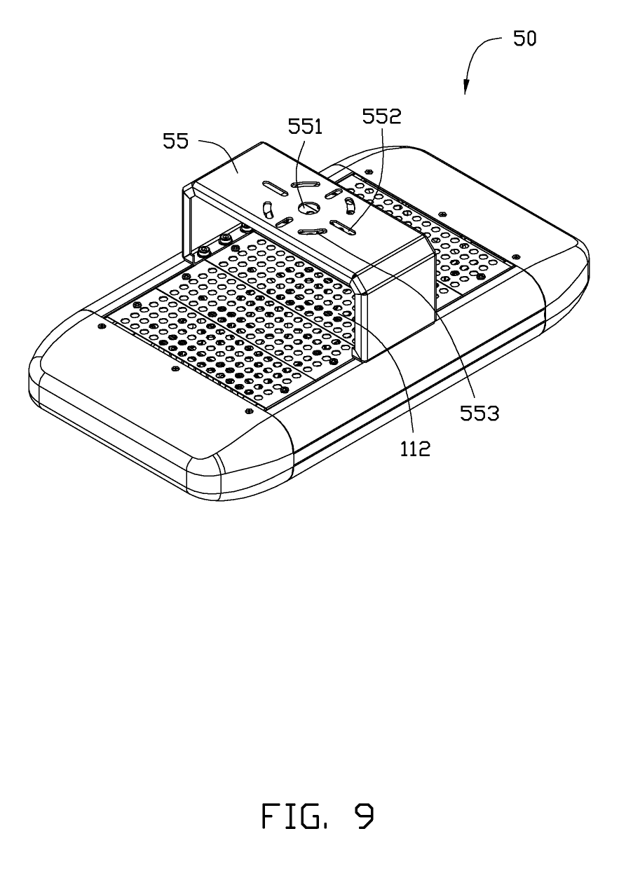

FIG. 9 presents an LED lamp 50 in accordance with a fifth embodiment of the present disclosure. The LED lamp 50 is similar to that of the first embodiment but differs from that of the first embodiment in a supporting rack 55. The supporting rack 55 of the LED lamp 50 is U-shaped. Two opposite ends of the supporting rack 55 are respectively mounted at two opposite ends of a middle one of the substrate 112. A middle segment of the supporting rack 55 is rectangular and defines a circular center hole 551, four elongated first holes 552 and four arc-shaped second holes 553 surrounding the center hole 551 for mounting the LED lamp 50 on a ceiling or a lamp pole. The first holes 552 and the second holes 553 are alternately arranged around the center hole 551. Every two distant first holes 552 are located at two opposite sides of the center hole 551 and collinear. When the LED lamp 50 is mounted through the two distant first holes 552, the LED lamp is moveable along the two distant holes 552 to change a position of the LED lamp 50. The second holes 553 and the center hole 551 are homocentric. When the LED lamp 50 is mounted through the center hole 551 and the second holes 553, the LED lamp 50 is rotatable with respect to the center of the center hole 551 to change a pose of the LED lamp 50.

It is to be understood, however, that even though numerous characteristics and advantages of the exemplary embodiments have been set forth in the foregoing description, together with details of the structures and functions of the embodiments, the disclosure is illustrative only; and that changes may be made in detail, especially in matters of shape, size, and arrangement of parts within the principles of the embodiments to the full extent indicated by the broad general meaning of the terms in which the appended claims are expressed.

What is claimed is:

1. A light-emitting diode lamp comprising:
a lamp shield comprising two side bars spaced from each other; and
a plurality of light-emitting diode modules located between the two side bars and arranged side by side along lengthwise direction of the side bars, each of the light-emitting diode modules being rotatably mounted to the two side bars.

2. The light-emitting diode lamp of claim 1, wherein each of the light-emitting diode modules is rotatably mounted on the two side bars by two positioning members.

3. The light-emitting diode lamp of claim 2, wherein each of the side bars defines a plurality of axial holes therein, the light-emitting diode is provided with two rotation members mounted adjacent to two opposite ends thereof, and each of the two positioning members extends through one of the rotation member and one axial hole of a corresponding side bar to rotatably mount the light-emitting diode module on the two side bars.

4. The light-emitting diode lamp of claim 3, wherein each of the side bars further defines a plurality of sliding slots therein corresponding to the axial holes, each of the sliding slots is adjacent to a corresponding axial hole, the sliding slot is arc-shaped and homocentric with the corresponding axial hole, a guiding member extends through the rotation member and the sliding slot, and the guiding member is slidable along the sliding slot when the LED modules rotate accompanying with the rotation member with respect to the positioning member.

5. The light-emitting diode lamp of claim 4, wherein the light-emitting diode module includes a front surface from which light emitted from and a back surface opposite to the front surface, the two rotation members are mounted on the back surface, each of the rotation members is L-shaped and includes a first connecting arm and a second connecting arm perpendicular to each other, the first connecting arm is mounted to the back surface of the light-emitting diode module, and the positioning member and the guiding member extend through the second connecting member.

6. The light-emitting diode lamp of claim 4, wherein each of the side bars includes a strip-shaped main plate, a first flange extending perpendicularly from a lateral side of the main plate, a second flange extending perpendicularly from a lateral side of the first flange, the second flange and the main plate are parallel to and face each other, and the axial holes and the sliding slots are defined in the second flange.

7. The light-emitting diode lamp of claim 4, wherein the axial hole is circular and adjacent to the first flange, the sliding slot is away from the first flange, and the axial hole is located between the first flange and the corresponding sliding slot.

8. The light-emitting diode lamp of claim 6, wherein each of the side bars is formed through aluminum extrusion, a plurality of heat dissipation structures are formed at an outer surface of the main plate opposite to the first flange and second flange.

9. The light-emitting diode lamp of claim 4, wherein the lamp shield further comprises a plurality of substrate and two baffle plates, the substrates are located between the two side bars and arranged side by side along lengthwise direction of the side bars, the two baffle plates are respectively located at two outsides of two outmost substrates, and a receiving space is cooperatively defined by the side bars, the baffle plate and the substrates for receiving the light-emitting diode modules.

10. The light-emitting diode lamp of claim 9, wherein each of the substrates defines a plurality of ventilation holes therein for dissipating heat of the light-emitting diode modules.

11. The light-emitting diode lamp of claim 9, further comprising two tip covers respectively mounted on the two baffle plates, wherein each of the tip covers is semi-elliptic and hollow, and a drive module is received in one of the tip covers.

12. The light-emitting diode lamp of claim 4, further comprising a supporting rack mounted on the lamp shield for mounting the light-emitting diode lamp.

13. The light-emitting diode lamp of claim 12, wherein the supporting rack comprises a pivot mounted on the lamp shield and a sleeve perpendicularly and rotatably intersecting with the pivot, and the lamp shield of the LED lamp is rotatable with respect to sleeve.

14. The light-emitting diode lamp of claim 12, wherein the supporting rack comprises a mounting flake, a first rotation plate and a second rotation plate, the mounting flakes is mounted on the lamp shield, the first rotation plate is mounted on the mounting flake, the first rotation plate defines two first guiding slots therein, the two first guiding slots are arc-shaped and axisymmetric with each other, a distance between the two first guiding slots decreases gradually towards the second rotation plate , the second rotation plate defines two second guiding slots therein, the two second guiding slots are arc-shaped and axisymmetric with each other, a distance between the two second guiding slots decreases gradually towards the first rotation plate, the first rotation plate and the second rotation plate are overlap with each other, each of the first guiding slots of the first rotation plate intersects a corresponding one of the second guiding slots of the second rotation plate, a fastener extends through an intersection of the first guiding slot and the corresponding second guiding slots to mount the first rotation plate and the second rotation plate together, and the fastener is slidable in the first guiding slot and the second guiding slot.

15. The light-emitting diode lamp of claim 14, wherein the second rotation plate comprises a main body and a mounting flange extending perpendicularly from a top lateral side of the main body , the second guiding slots are defined in the main body, the mounting flange is strip-shaped and defines two mounting holes therein adjacent to two opposite end thereof, the two mounting holes are strip-shaped, one of the mounting holes is parallel to the main body, and the other one of the mounting holes is perpendicular to the main body.

16. The light-emitting diode lamp of claim 12, wherein the supporting rack comprises two mounting flakes and a U-shaped portion, the two mounting flakes are respectively mounted on the lamp shield, two opposite ends of the U-shaped portion are rotatably mounted on the two mounting flakes respectively, and a middle segment of the U-shaped portion defines a plurality of mounting holes therein for mounting the LED lamp.

17. The light-emitting diode lamp of claim 12, wherein the supporting rack is U-shaped, two opposite ends of the supporting rack are mounted on the lamp shield, a middle segment of the supporting rack defines a circular center hole, a plurality of elongated first holes and a plurality of arc-shaped second holes surrounding the center hole for mounting the LED lamp, the first holes and the second holes are alternately arranged around the center hole, every two distant first holes are located at two opposite sides of the center hole and collinear, when the LED lamp is mounted through the two distant first holes, the LED lamp is moveable along the two distant holes, the second holes and the center hole are homocentric, and the LED lamp is rotatable with respect to the center hole when the LED lamp is mounted through the center hole and the second holes.
